(19) United States
(12) Patent Application Publication
(10) Pub. No.: US 2015/0168748 A1
(43) Pub. Date: Jun. 18, 2015

(54) HIGH FREQUENCY RESONATOR MODULATOR APPARATUS, METHOD AND APPLICATIONS

(71) Applicant: CORNELL UNIVERSITY, Ithaca, NY (US)

(72) Inventors: Michal Lipson, Ithaca, NY (US); Mohammad Soltani, Ithaca, NY (US); Lawrence Tzuang, Ithaca, NY (US)

(73) Assignee: CORNELL UNIVERSITY, Ithaca, NY (US)

(21) Appl. No.: 14/408,609

(22) PCT Filed: Jun. 20, 2013
(86) PCT No.: PCT/US2013/046721

§ 371 Date: Dec. 17, 2014

Related U.S. Application Data
(60) Provisional application No. 61/661,846, filed on Jun. 20, 2012.

(51) Int. Cl. G02F 1/025

(52) U.S. Cl. CPC G02F 1/025; G02F 2001/0151

(57) ABSTRACT

A ring resonator modulator and a modulation method that uses the ring resonator modulator each are predicated upon a modulation frequency of a ring shaped waveguide comparable to a free spectral range of the ring shaped waveguide. Fulfillment of this condition provides for a comparatively higher frequency optical modulation at a comparatively lower power consumption. A particular ring resonator modulator structure employs as an actuator a p-n diode that includes from about 25 to about 50 percent of the ring shaped waveguide and having a depletion region that is contained within the ring shaped waveguide.

### CROSS-REFERENCE TO RELATED APPLICATION

This application is related to, and derives priority from, U.S. Provisional Patent Application Ser. No. 61/661,846, filed 20 Jun. 2012 and titled Resonator Modulator Apparatus, Methods, and Applications, the contents of which is incorporated herein fully by reference.

### STATEMENT OF GOVERNMENT INTEREST

The research that lead to the embodiments as described herein, and the invention as claimed herein, was funded by: (1) the United States National Science Foundation through CIAN ERC under Grant EEC-0812072; and (2) the United States National Science Foundation under Grant No. 1202265. The United States Government has rights in the invention as claimed herein.

### BACKGROUND

1. Field of the Invention

Embodiments relate generally to optical resonator modulators. More particularly embodiments relate to optical resonator modulators with enhanced performance at comparatively high frequency operation.

2. Description of the Related Art

Achieving simultaneous low power consumption and high frequency operation of silicon resonator modulators is challenging since the modulation frequency is limited by the resonator linewidth. This difficulty hinders the utilization of these modulators in extremely high frequency (20-300 GHz) microwave photonic applications such as high speed analog communication and signal processing. However, the compactness, low drive voltage and low electrical power consumption in the silicon resonator modulators still make them attractive compared to alternative resonator modulator architectures such as Mach-Zehnder interferometer (MZI) based resonator modulator architectures.

Thus, since resonator modulators, including in particular silicon resonator modulators, are likely to remain desirable components within advanced optical network applications and related applications, desirable are additional resonator modulators, and in particular additional silicon resonator modulators, with enhanced performance.

### SUMMARY

The embodiments provide a ring resonator modulator (i.e., in particular a silicon ring resonator modulator) operative at frequencies higher than a resonance linewidth of the ring resonator modulator by using electrically induced photonic transitions between neighboring free spectral range (FSR) resonance modes in the ring resonator modulator. The embodiments demonstrate an exemplary non-limiting depletion-type silicon ring resonator modulator that efficiently induces such photonic transitions for high frequency applications.

A ring resonator modulator in accordance with the embodiments induces the photonic transitions by introducing a refractive index modulation that matches the frequencies and phases between adjacent resonance modes. For the frequency matching, the embodiments design a ring resonator modulator with its FSR equal to the desired modulation frequency (f_{M}). This FSR matching condition is further explained in the left graph of FIG. 1(a). In this figure, the electro-optic modulation produces sidebands which lead to photonic transitions from the carrier laser wavelength into the neighboring FSR resonance nodes when FSR is equal to, or comparable to, f_{M}.

A particular optical structure in accordance with the embodiments includes a ring shaped waveguide located over a substrate and characterized by a modulation frequency comparable to a free spectral range of the ring shaped waveguide.

Another particular optical structure in accordance with the embodiments includes a ring shaped waveguide located over a substrate. This other particular optical structure also includes an actuator comprising a p-n diode located within from 25 to 50 percent of the ring shaped waveguide. The p-n diode has a depletion region contained within the ring shaped waveguide.

A particular modulation method in accordance with the embodiments includes providing a ring resonator modulator comprising: (1) a ring shaped waveguide located over a substrate and characterized by a modulation frequency comparable to a free spectral range of the ring shaped waveguide; and (2) a bus waveguide coupled to the ring shaped waveguide, the bus waveguide having an optical input end and an optical output end. This particular method also includes supplying an optical signal at the optical input end of the bus waveguide while actuating the actuator to provide a modulated optical signal at the optical output end of the bus waveguide.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, that form a material part of this disclosure, wherein:

FIG. 1 shows (a) a depiction of optical spectra and corresponding energy level diagrams of a resonator modulator in accordance with the embodiments (left) and a standard ring resonator modulator (right) under a sinusoidal modulation with frequency f_{M}. In accordance with the embodiments, the FSR matches f_{M}, and in the standard ring modulator, FSR>>f_{M}. The vertical line indicates the laser wavelength. FIG. 1 also shows (b) an illustration of a ring resonator modulator scheme in accordance with the embodiments. The ring has a circumference length L (dashed line) and a segment length S (gray region) which is subject to refractive index modulation to provide non-zero mode coupling (see, e.g., Eq. (1)). The three arrows in (b) represent the propagation of the three FSR resonance modes with their designated resonance frequencies ωₘ₊ᵢ (i=−1,0,1) indicated.

FIG. 2 shows (a) an optical microscope image of a fabricated silicon ring resonator modulator device in accordance with the embodiments. The silicon ring has a radius of 445 μm, which corresponds to an FSR of 26 GHz at the optical wavelength of 1550 nm.

The modulation region covers only a quarter of the ring circumference (i.e., S=L/4), to obtain strong mode coupling between neighboring FSR resonances. FIG. 2 also shows (b) an illustration of a cross-section of the modulated region. A p-n diode with a depletion width D is formed inside the waveguide, and the silicon slab (50 nm) allows electrical access from the electrode to the p-n diode.

FIG. 3 shows measured optical spectra of the devices modulated with pure sinusoids at different frequencies f_{M} for: (a) the proposed ring resonator modulator in accordance with the embodiments with a measured FSR of 25.7 GHz; and (b) a reference ring resonator modulator with a measured large FSR of 750 GHz. The insets in (a) and (b) show the measured (top shaded black) and the simulated (lower lighter shaded) passive optical transmission (T) spectrum of the corresponding ring resonator modulators. Both ring resonator modulators show a quality factor Q of 16,000. The dotted arrows at the sides of the peaks depict the increase (decrease) of the modulation sideband amplitudes.

FIG. 4 shows a modulation response of a ring resonator modulator in accordance with the embodiments (upper lying lighter shaded curves) and the reference ring resonator modulator (lower lying darker shaded curves). The solid lines are experimental results and the dotted lines are theoretical predictions.

FIG. 5 shows a theoretical comparison of the power consumption versus the modulation frequency for a standard silicon ring resonator modulator (inclined dark shaded line) and the proposed ring resonator modulators in accordance with the embodiments (horizontal lighter shaded lines). In the simulations for a standard ring resonator modulator, the radius is 2.5 μm, and the Q varies for each modulation frequency to have an optimal resonance linewidth corresponding to that frequency. One can see that at higher frequencies the power consumption for the proposed ring resonator modulator becomes lower than the standard ring resonator modulator.

### DETAILED DESCRIPTION OF THE EMBODIMENTS

### 1. General Considerations

The embodiments provide a ring resonator modulator (i.e., in particular a silicon ring resonator modulator) operative at frequencies higher than a resonance linewidth of the ring resonator modulator by using electrically induced photonic transitions between neighboring FSR resonance modes in the ring resonator modulator. The embodiments demonstrate a depletion-type silicon ring resonator modulator that efficiently induces such photonic transitions for relatively high frequency applications in a range from 20 to 300 GHz, more preferably in a range from 30 to 300 GHz and most preferably in a range from 50 to 300 GHz. While the embodiments are particularly directed towards an illustrative but not limiting silicon ring resonator modulator, the embodiments are not intended to be so limited. Rather, the embodiments contemplate and consider ring resonator modulators comprising materials selected from the group including but not limited to conductor materials, semiconductor materials and dielectric materials. Similarly, while the embodiments are particularly directed towards an illustrative but not limiting silicon ring resonator modulator as a circular silicon ring resonator modulator, the embodiments contemplate and consider ring resonator modulators comprising ring shapes other than necessarily circular ring shapes, such as, for example and without limitation, ellipse ring shapes.

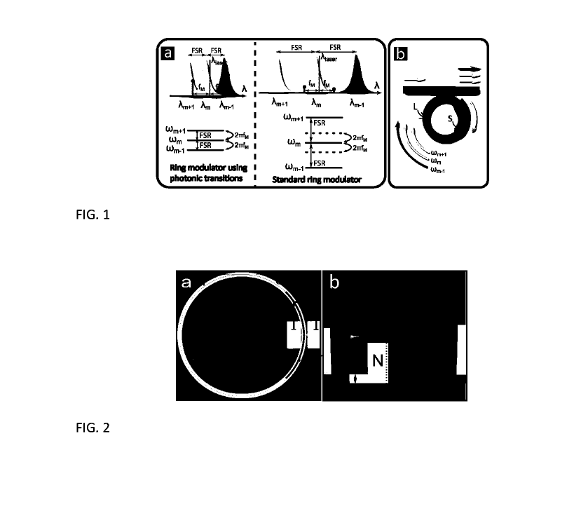

A ring resonator modulator in accordance with the embodiments induces the above described photonic transitions by introducing a refractive index modulation that matches the frequencies and phases between adjacent resonance modes. For the frequency matching, the embodiments design a ring resonator modulator with its FSR equal to the desired modulation frequency (f_{M}) (i.e., by “equal” or “comparable” with respect to an FSR and an f_{M} the embodiments intend that FSR and the f_{M} are preferably within 20 percent of each other, more preferably within 10 percent of each other, and most preferably within 5 percent of each other). This FSR matching condition is further explained in the left graph of FIG. 1(a). In this figure, the electro-optic modulation produces sidebands which lead to photonic transitions from the carrier laser wavelength into the neighboring FSR resonance nodes when FSR is equal to f_{M}. Therefore, the information that lies in the modulation sidebands is preserved even when the modulation frequency is much larger than the resonance linewidth of an individual resonance mode. In contrast, for standard ring resonator modulators (i.e., right graph of FIG. 1(a)) with an FSR much larger than the modulation frequency, the modulation leads to photonic transitions into forbidden bands with no allowed resonances. As a result, the information that lies in the modulation sidebands is not transmitted through the rings and is therefore lost. In order to break the orthogonality between the neighboring FSR resonance modes (and therefore achieve efficient transitions) one modulates only a portion of the ring (e.g., a single (or greater) portion of the ring, and particularly from 25 to 50 percent of the ring, more particularly from 30 to 40 percent of the ring, and most particularly from 40 to 50 percent of the ring. Although 50 percent modulation is advantageous, other issues such as better impedance matching and a travelling wave effect of the electrodes should be considered. The coupling coefficients μₙₘ, which represent the strengths of these photonic transitions, for such a modulation scheme can be theoretically (see Appendix A1) calculated as:

$${μ}_{nm} = - \frac{{ω}_{0}}{2 ɛ L} {\int }_{0}^{S} ( δ ɛ ) {e}^{j ( m - n ) \frac{2 π}{L} z} d z , \qquad ( 1 )$$

where ω₀ is the resonance angular frequency, ∈ is the dielectric constant, δ∈ is the dielectric constant modulation, L is the ring circumference, S is the electrode segment length (see FIG. 1(b)), m (and n) is the modal index of the resonance modes, and z is the direction along the perimeter of the ring. From Eq. (1), one can indeed see that the coupling coefficients for the nearest neighboring resonances (|m−n|=1) are nonzero when a portion of the ring is modulated (S<L).

For an ideal modulator design using this proposed scheme, the power-frequency tradeoff is broken since the size of the resonator (and therefore the power) scales inversely with increasing f_{M} (note that f_{M}=FSR=v_{g}/L, where v_{g} is the group velocity of light in the waveguide) and the Q can be arbitrarily high (further decreasing the necessary power consumption).

### 2. Experimental Results

One may design and fabricate a proposed silicon ring resonator modulator in accordance with the embodiments with a small FSR that matches a targeted modulation frequency of 26 GHz, and compare its performance with a reference ring resonator modulator where no photonic transitions are expected. An optical microscope image of the device is shown in FIG. 2(a). The radius of the ring is 445 μm, and only one quarter of the ring is covered with electrodes to break the orthogonality between neighboring FSR modes and generate strong mode coupling (see Appendix A1). In this quarter region, a p-n diode is formed inside the silicon waveguide as shown in FIG. 2(b) to provide fast modulation in silicon. Generally, a ring resonator modulator in accordance with the embodiments may have a radius from 300 to 600 μm, and more particularly from 400 to 500 μm; however, it is to be noted that the ring resonator modulator can be essentially radius as long as the FSR (=c/ng/(2πR) is comparable to the modulation frequency. The depletion width (D) of the p-n diode is subject to change when an electrical signal is applied across the electrodes in the reverse-biased regime. However, preferably the depletion region is, in operation of the ring resonator modulator, contained within ring waveguide. To assist in providing and securing this location of the depletion region, the p-n diode uses a p concentration and an n concentration each from about [1e17 to about 1e20 I/cm³]. The silicon ring has a cross-sectional dimension of 200 nm×450 nm on top of a 50 nm silicon slab. This waveguide dimension is specifically designed to support a single transverse-electric (TE) mode. One may, e.g., also fabricate a reference ring modulator (microscope image not shown) with a radius of 445 μm and a very large FSR of 750 GHz where the coupling between the adjacent FSR modes is forbidden in the frequency range of interest. The experimental results for the proposed modulator are compared with those obtained using this reference modulator. In order to have an equal resonance linewidth for both the reference and the proposed modulator, one may also dope one quarter of this reference ring modulator to the same doping concentration of the proposed modulator in accordance with the embodiments. A detailed description of the fabrication process can be found in Appendix A2.

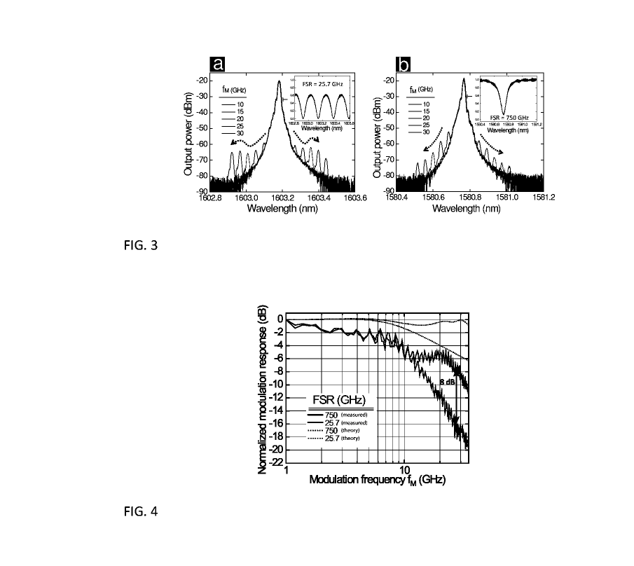

One may see the photonic transitions between neighboring FSR modes by measuring the optical spectrum of a resonator in accordance with the embodiments under RF modulations. The measurement protocol for this experiment is provided in Appendix A2, and the results for this experiment are shown in FIG. 3(a) and FIG. 3(b), respectively. In both figures, the broad peaks in the middle of the spectrum are located at the laser wavelength. The peaks located on the left and the right sides of the broad peaks are the generated modulation sidebands. In FIG. 3(a) these sidebands reach their local maxima at f_{M}=20 GHz (lighter shaded orange) and 25 GHz (lighter shaded red) on the right and the left side of the broad peak, respectively. This shows that the modulation sidebands at these frequencies are coupled into the nearest neighboring modes at approximately ±1 FSR away from the laser wavelength. In contrast, for the reference modulator (FIG. 3(b)), where the FSR is much larger than f_{M}, the modulation peaks continue to decrease as f_{M} increases.

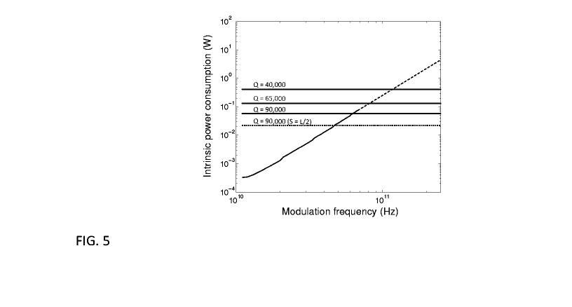

One may see that the photonic transitions lead to a high modulation response up to 20 GHz that surpasses the resonance linewidth roll-off at 11.7 GHz (calculated from a Q of 16,000). FIG. 4 shows the measured (solid) and the theoretical (dotted) normalized modulation response for both the proposed modulator resonator in accordance with the embodiments (lighter shaded red) and the standard silicon ring modulator (darker shaded black) (see Appendices A1 and A2 for details about the theoretical analysis and the measurement protocol). From this figure, one may see that the main features of the measured data match well with the theoretical expectations. The two experimental response curves have similar traces at frequencies up to the resonance linewidth of 11.7 GHz. However, when f_{M}>11.7 GHz, the response of the reference modulator decays continuously with a sharp roll-off as expected, whereas the response of the proposed modulator exhibits a local maximum at 20 GHz. Also from FIG. 4, one may clearly see a significant improvement of 8 dB in the response of the proposed modulator compared to the standard modulator at 27 GHz. Note that resonator modulators fabricated in accordance with the embodiments are RC limited. This is shown in FIG. 4 where the 3 dB roll-off frequency for both the proposed modulator (i.e., in accordance with the embodiments) and the reference modulator is about 9 GHz, which is smaller than the prediction from the theoretical curve. This also explains why the local extremum occurs at a frequency smaller than the anticipated FSR frequency of 25.7 GHz. A modulation scheme in accordance with the embodiments is not inherently limited by this RC response, and both the R and C can be reduced by improving the fabrication and optimizing the device structure.

Here one may also note that only the frequencies in the vicinity of the FSR frequencies benefit from using this proposed scheme as shown in FIG. 4. Therefore, this proposed scheme is more appropriate for high carrier frequency and narrow bandwidth analog applications.

### 3. Discussion

As the modulation frequency increases, a modulator in accordance with the embodiments has lower power consumption when compared with standard silicon ring resonator modulators. This effect is shown in FIG. 5 by plotting the theoretical intrinsic power consumption (assuming a perfect narrow bandwidth impedance matching LC network) for both the proposed ring resonator modulator scheme in accordance with the embodiments (lighter shaded horizontal lines) and the standard silicon ring resonator modulator (inclined darker shaded black line) at different modulation frequencies and different values of the resonator Q (see details about the analysis in Appendix A3). For this theoretical analysis, the power consumptions are calculated by assuming that the resonance frequency shift is one resonance linewidth in each cycle of the sinusoid modulation. The waveguide and doping geometry adopted for the simulations are shown in FIG. 2(b). The standard silicon ring resonator modulator in this analysis has a compact ring radius of 2.5 μm, a uniform modulation (S=L), and a varying Q to have an optimal resonance linewidth corresponding to f_{M}. The proposed ring resonator modulator considered here in accordance with the embodiments has a quarter of the ring being doped (S=L/4) and an FSR that matches f_{M}. In all cases, one may include a 1 dB/cm scattering loss to account for the fabrication imperfections of the ring. From FIG. 5, one may see that the proposed ring resonator modulator scheme can have lower power consumption than that of the standard ring resonator modulator when the Q increases, e.g. for a Q of 90,000 and at modulation frequencies >63 GHz. This is mainly because the standard ring resonator modulator designs need to lower the Q to accommodate higher modulation frequencies. In addition, at higher frequencies, the proposed scheme not only has a much higher Q, but also the size of the modulator (and the capacitance) becomes smaller such that the amount of carriers injected and extracted from the depletion region D (see FIG. 2(b)) is reduced. The dotted extrapolation black line for the standard ring modulator indicates where the voltage swing is larger than 10 V. This implies that the standard ring resonator modulators are fundamentally hard to modulate at these frequencies due to a potential breakdown of the p-n diodes. In contrast, for all cases of the proposed ring resonator modulator shown in FIG. 5, the voltage swing is below 10 V. Indicated by the dotted horizontal line in FIG. 5, one may also see a significant reduction of power when half of the ring is modulated. However, further increase of this S/L ratio will result in a reduction of the coupling strength between neighboring resonances. The power consumption of the modulators shown in FIG. 5 can potentially be improved by further optimizing the p-n diode.

### 4. Conclusion

In summary, the embodiments provide both in theory and experiment that silicon ring resonator modulators can be modulated at frequencies beyond the resonance linewidth using photonic transitions between neighboring FSR resonances. The proposed modulator in accordance with the embodiments can simultaneously achieve low power consumption and high frequency operation. Additionally, the proposed modulation scheme in accordance with the embodiments may be applied to all other resonator and material systems by using other modulation schemes. This modulator architecture is promising for extremely high frequency analog applications using existing CMOS technology.

### APPENDIX

### A1. Model of a Ring Resonator Modulator Including Coupling Between Neighboring FSR Resonances

One may develop a model for a resonator-based modulator that considers all the FSR resonance modes. The individual time-domain dynamical equations that represent the amplitude change in each of the FSR resonance modes are coupled through the mode coupling coefficient μₙₘ:

$$\frac{d {a}_{m} ( t )}{d t} = ( j {ω}_{m} - j {ω}_{L} - \frac{1}{{τ}_{0}} - \frac{1}{{τ}_{c}} ) {a}_{m} ( t ) + j \sum {μ}_{nm} ( t ) {a}_{n} ( t ) + κ {S}_{w} , \qquad ( 2 )$$

where m and n are the mode indices of the resonance mode, aₘ₍ₙ₎(t) is the amplitude of the m(n)^{th} mode inside the ring, ωₘ is the resonance frequency, ω_{L} is the laser frequency, κ is the coupling coefficient between the ring resonator and the bus-waveguide, S_{w} is the amplitude from the waveguide input, and τ₀ and τ_{c} are the intrinsic and coupling time constants which together dictate the Q. The coupling term μₙₘ is written as:

$${μ}_{nm} = - \frac{\frac{{ω}_{n}}{4} \int \int \int δ ɛ ( z , t ) {E}_{r , n} {E}_{r , m}^{*} d x d y d z}{\frac{1}{2} \int \int \int {ɛE}_{r , m} {E}_{r , m}^{*} d x d y d z} , \qquad ( 3 )$$

where E_{r,m} is the spatial electric field distribution of the modes with mode index m, ∈ is the dielectric constant, and δ∈ is the dielectric constant modulation. The x-, y-, and z-axes are defined in FIG. 2(b). The mode E_{r,m} can be expressed as E_{c}(x,y)·e^{-jq(2πz/L)} in which E_{c}(x,y) is the cross-section mode profile of the waveguide that forms the ring. One may then obtain Eq. (1) by inserting E_{r,m} into Eq. (3) and normalize the waveguide mode

$$( i . e . \frac{1}{2} \int {\int }_{∞}^{ } ɛ {\vert {E}_{c} ( x , y ) \vert}^{2} d x d y = 1 ) .$$

One may optimize the coupling by using S=L/4 for the proposed ring modulator scheme. From Eq. (1), one can find that the magnitude of the nearest neighboring coupling (|n−m|=1) is largest when S=L/2. However, in experiments, one may sacrifice about 30% of this coupling strength by using S=L/4 in exchange for both higher electrode bandwidth (limited by the driver impedance) and optical Q.

The modulation response is obtained by finding the maximum and minimum of the transient optical transmission at different modulation frequencies. This transmission is calculated from the amplitudes for each of the resonance modes that were numerically solved through Eq. (2) using the coupling coefficients obtained from Eq. (1). One may also assume that the ring resonator is always operating at the critical coupling condition (τₒ=τ_{c}).

### A2. Device Fabrication and Experimental Characterization

The device fabrication process starts with defining the waveguide patterns using electron beam lithography (EBL) on a silicon-on-insulator wafer followed by plasma etching. Subsequently, with four steps of EBL and ion implantation, the doping regions of N/N+(with phosphorus dopants) and P/P⁺ (with boron dopants) are defined as shown in FIG. 2(b). In order to increase the modulation efficiency, the width of the P doped region is slightly (˜100 nm) larger than the N doped region. The doping level of the P and the N regions are ˜1×10¹⁸ 1/cm³, and that of the P⁺ and N⁺ regions are ˜1×10²⁰ 1/cm³. The device is then top cladded with a 950 nm PECVD SiO₂ layer. The dopants are then activated in a furnace at subsequent temperatures of 550° C. and 900° C., followed by a short period of rapid thermal annealing at 1,050° C. Next, the via regions are defined by using EBL followed by a dry etching step to remove SiO₂ overlay from the highly doping layers P⁺ and N⁺. Then an 80 nm MoSi₂ thin film is deposited inside the vias using a lift-off process to create a good electrical interface between the highly doped layers and the aluminum (A1) metal contacts, which are sputtered in the final step. The thickness of the A1 contacts is about 1.6 μm.

For the optical spectra measurements shown in FIG. 3, a 5 dBm RF sinusoid signal is applied on the device pads (through a 50 GHz ground-signal probe) from a signal generator (Agilent 8257D). The DC bias is set at −2 V applied through a 65 GHz bias-tee. The output spectra are then collected by an optical spectrum analyzer (ANDO AQ6371).

In order to characterize the device modulation response shown in FIG. 4, a small RF signal (−17 dBm) is applied to the device pads (through a 50 GHz ground-signal probe) from the network analyzer (Agilent E8364B PNA Series). The signal has a DC bias of −1 V through a 65 GHz bias-tee. The output modulated light is then amplified through an L-band EDFA before entering to a 40 GHz photodetector which is connected to the network analyzer. One may then obtain the normalized modulation response by reading out the scattering matrix element S₁₂ from the network analyzer and normalize it to its value at 1 GHz.

### A3. Power Consumption of the Silicon Ring Modulators

One may analyze the power consumption of the silicon ring modulators using commercial available software: SILVACO and COMSOL. The embodiments use SILVACO to simulate the voltage dependence of the doping profile from different doping concentrations. This doping profile is then mapped to a refractive index distribution in an optical waveguide, which is then imported into COMSOL to calculate the effective refractive indices and optical losses. The geometry and doping profile of the waveguide for this simulation are shown in FIG. 2(b).

One may estimate the power consumption for a standard silicon ring modulator operating at different f_{M} as follows: first, one may obtain the Q by using the relation: Q=ω₀/(2πf_{M}). Second, one may use this Q to estimate the doping concentration N from the total optical loss. For this step, because the doping loss is only part of the overall loss that determines the Q, one may add a 1 dB/cm scattering loss assuming the fabrication imperfections for the ring resonator. Here one may also assume that P and N doping have the same doping level. The bending losses are neglected in our calculations by assuming a minimum ring radius R of 2.5 μm. Third, one may use the N determined in the previous step to simulate the diode capacitance per unit length C_{d} (in SILVACO) and the required voltage Vₚₚ across the p-n diode to modulate the resonance frequency one full resonance linewidth (i.e. Δω=ω₀/Q). Finally, one may obtain the power consumption from the expression: f_{M}LC_{d}V²ₚₚ.

The power consumption for the proposed silicon ring modulator is estimated as follows: first, one may specify a Q. Then, from this Q one may find the doping concentration N from the total optical loss. Here, a 1 dB/cm scattering loss is also included in the calculation. Next, based on this N, one may simulate the capacitance per unit length C_{d} (in SILVACO) and voltage Vₚₚ from to modulate this resonance one full linewidth. Finally, the power consumption is calculated from the expression: f_{M} SC_{d}V²ₚₚ, where S is determined by the FSR of the ring resonator that matches the modulation frequency. Notice that since S is inverse proportional to f_{M}, the power consumption of the proposed silicon ring modulator should be constant across frequency for a constant Q. In all the above analysis, one may neglect the optical loss change during the refractive index modulation.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An optical component comprising a ring shaped waveguide located over a substrate and characterized by a modulation frequency comparable to a free spectral range of the ring shaped waveguide.

2. The optical component of claim 1 wherein the optical component comprises a ring resonator modulator.

3. The optical component of claim 1 wherein the ring shaped waveguide comprises a material selected from the group consisting of dielectric materials, semiconductor materials and conductor materials.

4. The optical structure of claim 1 wherein the ring shaped waveguide comprises a semiconductor material.

5. The optical component of claim 4 wherein the ring shaped waveguide comprises a silicon semiconductor material.

6. The optical component of claim 1 further comprising an actuator component.

7. The optical component of claim 6 wherein the actuator component comprises a p-n diode integral to the ring shaped waveguide.

8. The optical component of claim 7 wherein the p-n diode comprises a single p-n diode that includes from 25 to 50 percent of the ring shaped waveguide.

9. The optical component of claim 7 wherein a depletion region of the p-n diode is located contained within the ring shaped waveguide.

10. The optical component of claim 7 wherein the p-n diode includes:
a p dopant at a concentration from about 1e17 to 1e20 ions per cubic centimeter; and
an n dopant at a concentration from about 1e17 to about 1e20 ions per cubic centimeter.

11. The optical component of claim 1 further comprising a bus waveguide coupled to the ring shaped waveguide, the bus waveguide having an input end and an output end.

12. An optical component comprising:
a ring shaped waveguide located over a substrate;
an actuator comprising a p-n diode located within from 25 to 50 percent of the ring shaped waveguide, the p-n diode having a depletion region contained within the ring shaped waveguide.

13. The optical component of claim 12 wherein the ring shaped waveguide is characterized by a modulation frequency comparable to a free spectral range of the ring shaped waveguide.

14. The optical component of claim 12 wherein the p-n diode includes:
a p dopant at a concentration from about 1e17 to about 1e19 ions per cubic centimeter; and
an n dopant at a concentration from about 1e17 to about 1e19 ions per cubic centimeter.

15. The optical component of claim 12 further comprising a bus waveguide coupled to the ring shaped waveguide, the bus waveguide having an input end and an output end.

16. A modulation method comprising:
providing a ring resonator modulator comprising:
a ring shaped waveguide located over a substrate and characterized by a modulation frequency comparable to a free spectral range of the ring shaped waveguide; and
a bus waveguide coupled to the ring shaped waveguide, the bus waveguide having an optical input end and an optical output end;
supplying an optical signal at the optical input end of the bus waveguide while actuating the actuator to provide a modulated optical signal at the optical output end of the bus waveguide.

17. The method of claim 16 wherein the actuator comprises a single actuator.

18. The method of claim 16 wherein the single actuator comprises a single p-n diode that includes from 25 to 50 percent of the ring shaped waveguide.

19. The method of claim 16 wherein a depletion region of the p-n diode is contained within the ring shaped waveguide.

20. The method of claim 16 wherein the actuating the actuator is undertaken at a frequency greater from 20 to 300 GHz.
